(19) United States
(12) Patent Application Publication
(10) Pub. No.: US 2004/0083599 A1
(43) Pub. Date: May 6, 2004

(54) Method of manufacturing a stacked core for a magnetic induction device

(76) Inventor: Benjamin Weber, Winterberg (DE)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/250,534

(22) PCT Filed: Dec. 28, 2001
(86) PCT No.: PCT/IB01/02881

(51) Int. Cl. H01F 27/24

(52) U.S. Cl. 29/602.1; 29/609; 336/213; 29/417

(57) ABSTRACT

A presently-preferred method of manufacturing a stacked core for a magnetic-induction device comprises cutting a sheet of magnetic material into one or more strips of the magnetic material so that a width of each strip changes along a length of the strip. The presently-preferred method also comprises cutting the strips to form a plurality of laminae having different widths. The presently-preferred method further comprises stacking and bonding the laminae to form a winding leg, an outer leg, or a yoke having laminae of relatively large width positioned at its approximate center, laminae of relatively small width positioned at its outer edges, and laminae of progressively decreasing width positioned between the center and the edges.

This application claims priority under 35 U.S.C. § 119(e) to U.S. Provisional Patent Application Serial No. 60/259,205, which was filed on Dec. 29, 2000 and is hereby incorporated by reference in its entirety.

### FIELD OF THE INVENTION

The present invention relates to magnetic-induction devices such as electrical-power transformers. More specifically, the invention relates to the manufacture a stacked core for a magnetic-induction device.

### BACKGROUND OF THE INVENTION

Electrical-power transformers are used extensively in electrical and electronic applications. Transformers transfer electric energy from one circuit to another circuit through magnetic induction. Transformers are utilized to step electrical voltages up or down, to couple signal energy from one stage to another, and to match the impedances of interconnected electrical or electronic components. Transformers are also used to sense current, and to power electronic trip units for circuit interrupters. Transformers may also be employed in solenoid-equipped magnetic circuits, and in electric motors.

A typical transformer includes two or more multi-turned coils of wire commonly referred to as “phase windings.” The phase windings are placed in close proximity so that the magnetic fields generated by each winding are coupled when the transformer is energized. Most transformers have a primary winding and a secondary winding. The output voltage of a transformer can be increased or decreased by varying the number of turns in the primary winding in relation to the number of turns in the secondary winding.

The magnetic field generated by the current passing through the primary winding is typically concentrated by winding the primary and secondary coils on a core of magnetic material. This arrangement increases the level of induction in the primary and secondary windings so that the windings can be formed from a smaller number of turns while still maintaining a given level of magnetic-flux. In addition, the use of a magnetic core having a continuous magnetic path ensures that virtually all of the magnetic field established by the current in the primary winding is induced in the secondary winding.

An alternating current flows through the primary winding when an alternating voltage is applied to the winding. The value of this current is limited by the level of induction in the winding. The current produces an alternating magnetomotive force that, in turn, creates an alternating magnetic flux. The magnetic flux is constrained within the core of the transformer and induces a voltage across in the secondary winding. This voltage produces an alternating current when the secondary winding is connected to an electrical load. The load current in the secondary winding produces its own magnetomotive force that, in turn, creates a further alternating flux that is magnetically coupled to the primary winding. A load current then flows in the primary winding. This current is of sufficient magnitude to balance the magnetomotive force produced by the secondary load current. Thus, the primary winding carries both magnetizing and load currents, the secondary winding carries a load current, and the core carries only the flux produced by the magnetizing current.

In an ideal transformer, all of the magnetic flux produced by the primary winding reaches and cuts the secondary winding. In reality, however, some of the flux produced by the windings does not flow through the core, but rather “escapes” into the space surrounding the windings. This concept is commonly referred to as “flux leakage.” Flux leakage reduces the induced voltage in the secondary winding from its ideal value, and is therefore undesirable.

One potential source of flux leakage is the presence of gaps (spaces) between the primary and secondary windings and the winding leg. These gaps are present when the windings fail to conform fully to the shape of the winding leg. Thus, the gaps are closely related to the geometric configuration of the winding leg. For example, FIG. 7 depicts a winding leg 100 having a substantially square cross-section, and a phase winding 102 positioned on the winding leg 100. Gaps 104 are present between the winding leg 100 and the winding 102 due to the inability of the wound, circular phase winding 102 to conform to the surface of the winding leg 100 proximate its corners. FIG. 6 depicts a winding leg 18 having a substantially circular cross-section, with a circular phase winding 31a positioned thereon. FIG. 6 demonstrates that the use of a winding leg 18 of circular cross-section results in virtually no gaps between the phase winding 31a and the winding leg 18. Hence, a winding leg having a substantially circular (or elliptical) cross-section represents the optimal configuration with respect to minimizing flux leakage.

The constituent elements of a stacked transformer core, i.e., the winding leg(s), yokes, and outer legs, are formed from a plurality of laminae that are stacked (superposed) to a predetermined depth and bound together. Constituent elements having non-circular cross-sections are typically formed using laminae having different widths (or “x” dimensions as denoted in FIGS. 6 and 7). For example, the winding leg 18 having a substantially circular cross-section comprises relatively wide laminae 26 at and near its approximate center 18a (see FIG. 6). Laminae 26 of progressively narrower widths are used between the approximate center 18a and outer edges 18b, 18c of the winding leg 18 so that the cross-section of the winding leg 18 approximates a circle. The winding leg 100 having a square cross-section, on the other hand, comprises laminae 114 of approximately equal width.

The use of identically-sized laminae simplifies the manufacturing process for a core made up of constituent elements comprising such laminae, e.g., the winding leg 100. In particular, the use of substantially identical laminae reduces the number of different types of parts that must be manufactured and handled as the core is produced. In addition, the use of identically-sized laminae generally results in little or no waste of the magnetic material used to form the laminae. Hence, a transformer core having identically-sized laminae can, in general, be manufactured with less time, effort, and expense than a comparable core comprising laminae of different sizes.

In light of the above discussion, it is evident that an ongoing need exists for a method of manufacturing a stacked transformer core comprising constituent elements having substantially circular cross-sections, where the method does not require the additional time, effort, and expense needed to achieve this feature using conventional manufacturing methods.

### SUMMARY OF THE INVENTION

A presently-preferred method of manufacturing a stacked core for a magnetic-induction device comprises cutting one or more strips of magnetic material from a sheet of the magnetic material so that each of the strips has a width that varies in a predetermined manner along a length of the strip. The presently-preferred method also comprises cutting the one or more strips to form a plurality of laminae, and stacking and bonding the laminae to form a winding leg having a substantially circular cross-section.

Another presently-preferred method of manufacturing a stacked core for a magnetic-induction device comprises forming a strip of magnetic material of varying width, forming laminae of different widths from the strip of magnetic material, and stacking and bonding the laminae to form a winding leg.

Another presently-preferred method of manufacturing a stacked core for a magnetic-induction device comprises cutting a sheet of magnetic material into one or more strips so that a width of each of the strips changes in a predetermined manner along a length of the strip, and cutting the strips to form a plurality of laminae having different widths. The presently-preferred method also comprises stacking the laminae to form a stack of the laminae having laminae of relatively large width positioned at an approximate center of the stack, laminae of relatively small width positioned at outer edges of the stack, and laminae of progressively decreasing width positioned between the approximate center and the outer edges of the stack. The presently-preferred method further comprises bonding the laminae to form a winding leg.

Another presently-preferred method of manufacturing a stacked core for a magnetic-induction device comprises cutting a sheet of magnetic material into a strip of the magnetic material having a width that decreases progressively along a length of the strip. The presently-preferred method also comprises cutting the strip to form a plurality of laminae having different widths, and stacking the laminae in a sequence substantially identical to a sequence in which the laminae are cut from the strip so that the laminae are arranged in an order of progressively changing width.

Another presently-preferred method of manufacturing a stacked core for a magnetic-induction device comprises cutting a sheet of magnetic material along a substantially curvilinear path to form a strip of the magnetic material having a varying width, cutting the strip to form a plurality of laminae, and stacking and bonding the laminae to form a winding leg.

A presently-preferred stacked transformer core comprises a winding leg formed from a plurality of laminae having different widths. The laminae are stacked and bonded so that laminae of relatively large width are positioned at an approximate center of the winding leg, laminae of relatively small width are positioned at outer edges of the winding leg, and laminae of progressively decreasing width are positioned between the approximate center and the outer edges of the winding leg, whereby a cross-section of the winding leg is substantially circular.

### BRIEF DESCRIPTION OF THE DRAWINGS

The foregoing summary, as well as the following detailed description of a presently-preferred method, is better understood when read in conjunction with the appended drawings. For the purpose of illustrating the invention, the drawings depict a stacked core that is capable of being manufactured in accordance with the presently-preferred method provided by the invention. The invention is not limited, however, to use with the specific core disclosed in the drawings. In the drawings:

FIG. 1 is a diagrammatic illustration of a stacked core for a magnetic induction device manufactured in accordance with a presently-preferred method provided by the invention;

FIG. 2 is a partially-exploded perspective view of the core shown in FIG. 1;

FIG. 3A is a plan view of a lamina used to form an upper yoke and a lower yoke of the core shown in FIGS. 1 and 2;

FIG. 3B is a plan view of a lamina used to form a winding leg of the core shown in FIGS. 1 and 2;

FIG. 3C is a plan view of a lamina used to form outer legs of the core shown in FIGS. 1 and 2;

FIG. 4 is a perspective view of a portion of a sheet of magnetic material from which the laminae shown in FIGS. 3A-3C can be formed;

FIG. 5 is a perspective view of a portion of a strip of magnetic material formed from the sheet of magnetic material shown in part in FIG. 4;

FIG. 6 is a cross-sectional view of a winding leg of the core shown in FIGS. 1 and 2, taken along the line “6-6” of FIG. 2; and

FIG. 7 is a cross-sectional view of a winding leg having a square cross-section, for use in a stacked core for a magnetic induction device.

### DESCRIPTION OF PREFERRED EMBODIMENTS

The present invention relates to the manufacture of a stacked core for a magnetic induction device such as an electrical-power transformer. A presently-preferred method is described in connection with a dry, single-phase, three-legged shell-type transformer. This type of transformer is described for exemplary purposes only; the invention is applicable to virtually any transformer having a stacked core, including multi-phase transformers of both the core and shell type, oil-filled transformers, and transformers having more or less than three legs. Furthermore, the invention is applicable to magnetic-induction devices other than electrical-power transformers.

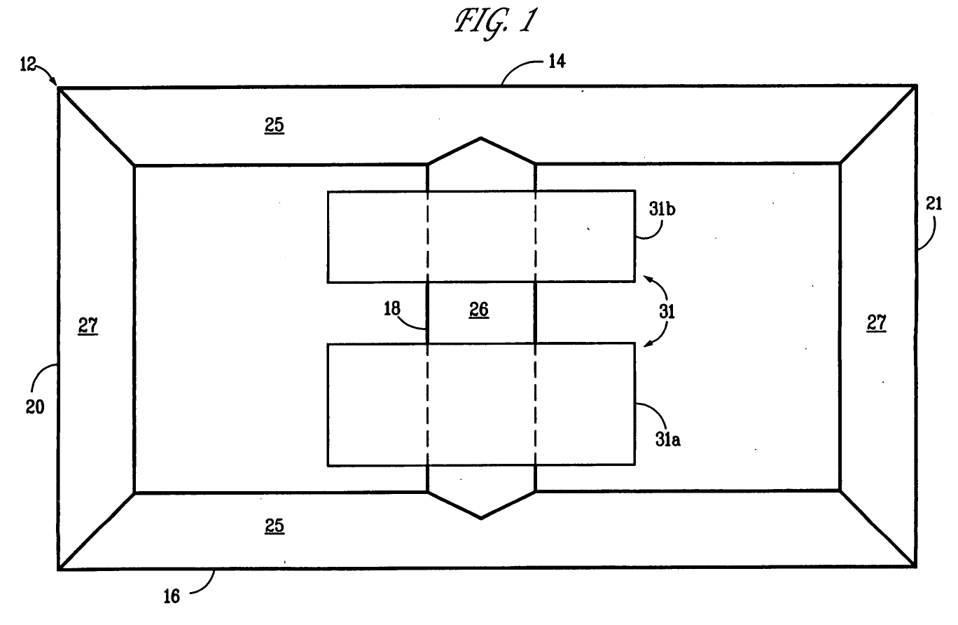

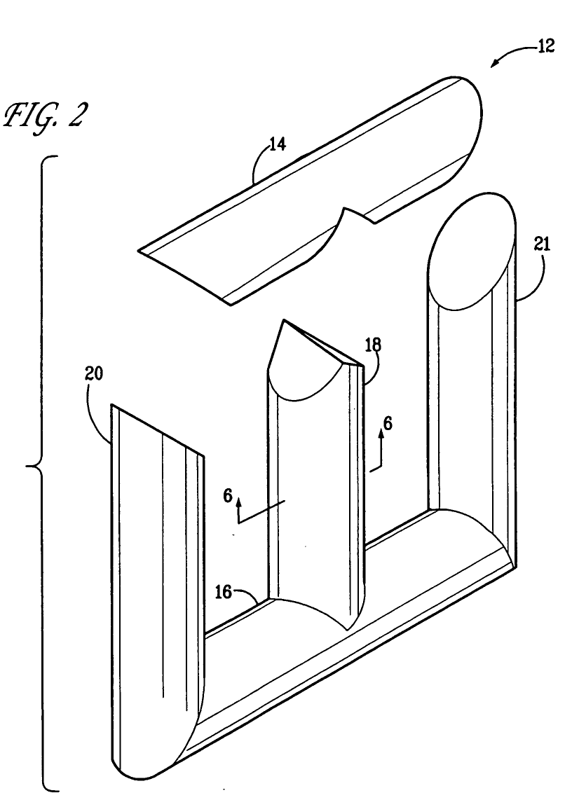

FIGS. 1-3C and 6 depict a stacked core 12 manufactured in accordance with a presently-preferred method provided by the invention. The core 12 comprises the above-referenced winding leg 18, an upper yoke 14, a lower yoke 16, and first and second outer legs 20, 21.

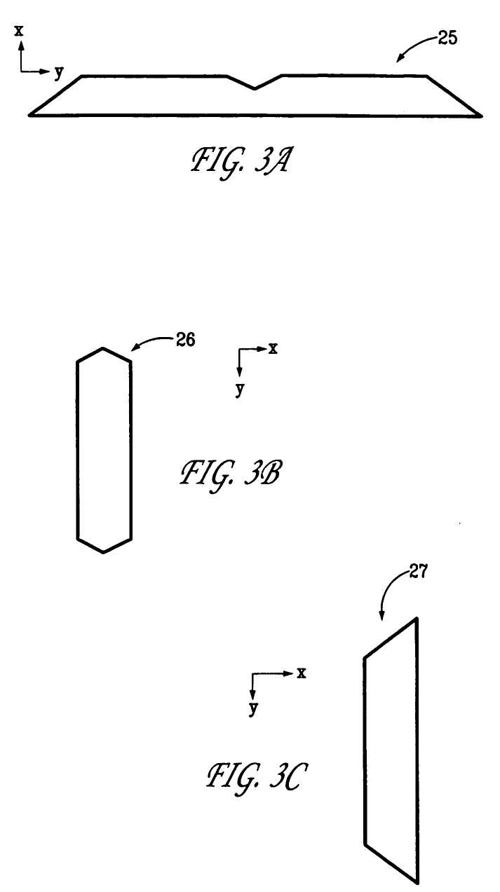

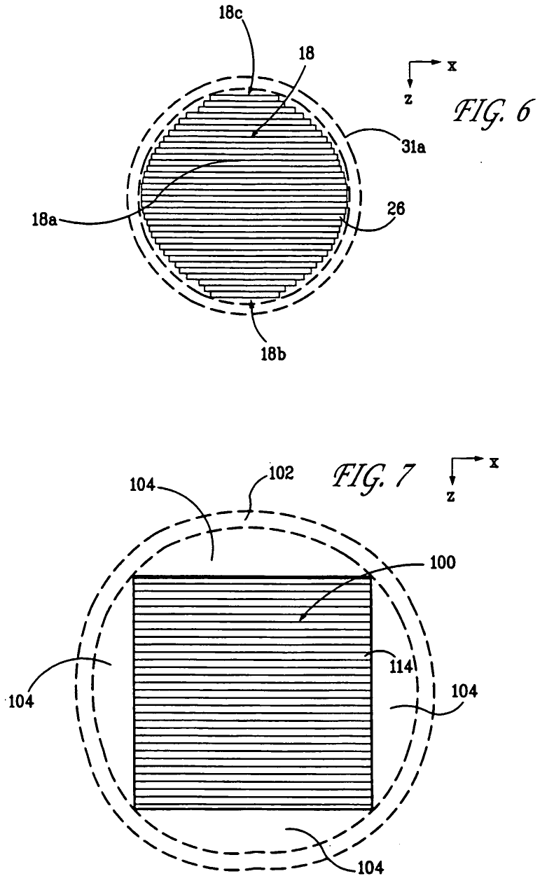

The winding leg 18 is formed from a plurality of the laminae 26, as mentioned above. The laminae 26 each have the general shape depicted in FIG. 3B. The laminae 26 are stacked, i.e., superposed, to a predetermined depth and bound together by a suitable means such as adhesive to form the winding leg 18. The laminae 26 are formed in different widths, as explained in detail below. (The terms “width” and “length,” as used throughout the specification and claims, refer to dimensions coinciding with the “x” and “y” directions, respectively, denoted in selected figures.) The widest laminae 26 are positioned at an approximate center 18a of the winding leg 18, and the narrowest laminae 26 are positioned at the outer edges 18b, 18c of the winding leg 18 (see FIG. 6). The laminae 26 are arranged so that the laminae 26 progressively decrease in width between the approximate center 18a and the outer edges 18b, 18c of the winding leg 18. This arrangement causes the cross-section of the winding leg 18 to approximate a circle, as shown in FIG. 6.

The upper and lower yokes 14, 16 are formed from a plurality of laminae 25 having the general shape depicted in FIG. 3A. The laminae 25 are stacked to a predetermined depth and bound together to form the upper and lower yokes 14, 16. The laminae 25 are formed in different widths, and are stacked in a manner similar to the laminae 26 so that the cross-sections of the upper and lower yokes 14, 16 each approximate a circle.

The first and second outer legs 20, 21 are formed from a plurality of laminae 27 having the general shape depicted in FIG. 3C. The laminae 27 are stacked to a predetermined depth and bound together to form the outer legs 20, 21. The laminae 27 are formed in different widths, and are stacked in a manner similar to the laminae 26 so that the cross-sections of the outer legs 20, 21 each approximate a circle.

Opposing ends of the first and second outer legs 20, 21 are fixedly coupled to ends of the upper and lower yokes 14, 16, as shown in FIG. 1. Opposing ends of the winding leg 18 are fixedly coupled to the approximate mid-points of the upper and lower yokes 14, 16. The yokes 14, 16, winding leg 18, and outer legs 20, 21 can be fixedly coupled by any suitable means such as interlocking protrusions and recesses formed along the contacting surfaces, or welding. The ends of the upper and lower yokes 14, 16, the winding leg 18, and the first and second outer legs 20, 21 are beveled to facilitate the use of miter joints. This configuration is presented for exemplary purposes only, as the upper and lower yokes 14, 16, the winding leg 18, and the first and second outer legs 20, 21 can be coupled using virtually any type of interface.

A coil 31 is positioned around the winding leg 18 (see FIG. 1). The coil 31 comprises a primary phase winding 31a and a secondary phase winding 31b. The primary phase winding 31a is adapted for connection to an alternating-current power source (not shown), and the secondary phase winding 31b is adapted for connection to a load (also not shown). The primary and secondary phase windings 31a, 31b are inductively coupled via the core 12 when the primary phase winding 31a is energized by the power source. In particular, the alternating voltage across the primary phase winding 31a sets up an alternating magnetic flux in the core 12. This flux induces an alternating voltage across the secondary phase winding 31b (and the load connected thereto). (The noted coil configuration is presented for exemplary purposes only; the invention is equally applicable to transformers comprising coils having one, or more than two windings.)

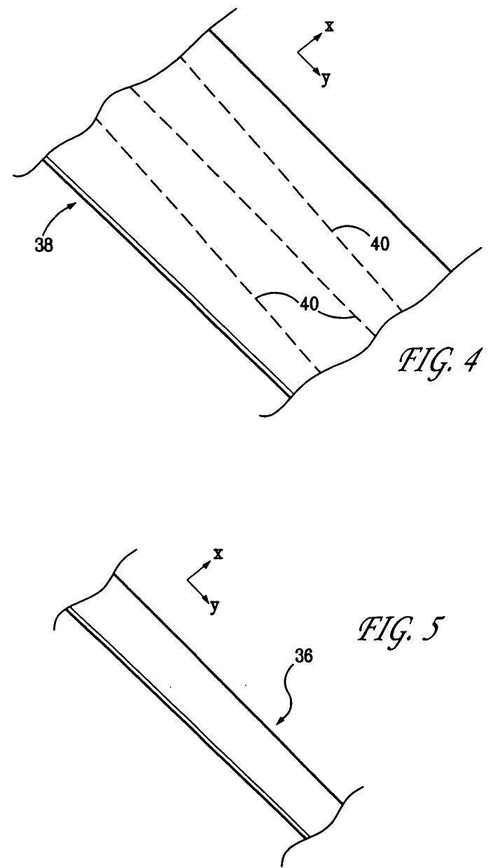

Details concerning the manufacture of the core 12 are as follows. The laminae 25, 26, 27 are formed from a piece of suitable magnetic material such as textured silicon steel or an amorphous alloy. In particular, the laminae 25, 26, 27 may be formed from a thin strip 36 of magnetic material (hereinafter referred to as a “material strip”). A portion of one of the material strips 36 is shown in FIG. 4. The material strip 36 is typically cut from a larger sheet of magnetic material, e.g., a 1.0 m (39 in.) wide, 0.30 mm (0.012 in.) thick, 200 m (656 ft.) long rolled sheet of textured silicon steel or amorphous alloy (hereinafter referred to as a “material roll 38”). A portion of the material roll 38 is depicted in FIG. 4. (The terms “cut” and “cutting,” as used throughout the specification and claims, are intended to cover all types of operations in which a piece of material is separated into two or more pieces, including but not limited to shearing, punching, stamping, and slicing).

The material strips 36 are cut from the material roll 38 so that each material strip 36 has a width (“x” dimension) that varies continuously along the length (“y” dimension) of the material strip 36 (see FIG. 5). For example, the material roll 38 may be cut along the predetermined paths depicted by the lines 40 shown in FIG. 4, thus forming four of the material strips 36. Further details concerning the variation in width of the material strips 36 are presented below. (FIG. 4 demonstrates that an entirety of the material sheet 38 can be used to form the material strips 36, thus avoiding any waste of the magnetic material that makes up the material sheet 38.)

Each material strip 36 is subsequently cut to form a plurality of the laminae 25, the laminae 26, or the laminae 27. The laminae 25 are subsequently stacked to form the winding leg 18. The laminae 26 are likewise stacked to form the yokes 14, 16, and the laminae 27 are stacked to form the outer legs 20, 21. Note: The material strips 36 used to form the respective laminae 25, laminae 26, and laminae 27 may be cut from different material rolls 38. Alternatively, one of the material rolls 38 may be cut to form a plurality of material strips 36 that are subsequently formed into the laminae 25, laminae 26, and laminae 27. In other words, the laminae 25, laminae 26, and laminae 27 can be formed from different material rolls 38 or, alternatively, from a common material roll 36 or set of material rolls 36.

The laminae 25 are stacked in a manner that causes the winding leg 18 to have the cross-sectional profile shown in FIG. 6. In other words, the laminae 25 are stacked so that the laminae 25 of relatively large width are positioned at the approximate center 18a of the winding leg 18, while the laminae 25 of relatively small width are positioned at the outer edges 18b, 18c of the winding leg 18. Thus, the widths of the individual laminae 25 decrease progressively between the approximate center 18a and the outer edges 18b, 18c of the winding leg 18. This progressive change in width causes the cross-section of the winding leg 18 to approximate a circle.

The width of each individual lamina 25 is determined by the width of the material strip 36 from which the lamina 25 is formed. Each material strip 36, as noted above, is cut from the material roll 38 in a manner that causes the width of the material strip 36 to vary in a predetermined manner. The desired variation in width of the material strips 36 is preferably achieved using an algorithm. In other words, the locations of the lines 40 shown in FIG. 4 are preferably chosen by an algorithm. This algorithm causes the width of the laminae 25 cut from each material strip 36 to vary progressively along the length of the material strip 36. This progressive variation in width causes the laminae 25 to form a stack having a predetermined cross-sectional profile when the laminae 25 are stacked in the sequence in which they were cut from the material strip 36.

Note: Differences in width between opposing ends of each lamina 25 are very small and, in most cases, can be considered negligible when the laminae 25 are stacked to form the winding leg 18. Alternatively, the laminae 25 can be stacked so that adjacent laminae 25 in approximately one half of the stack are oriented with their wider ends at one end of the stack. The remaining laminae 25 can be oriented with their wider ends located at the opposing end of the stack. This arrangement causes the cross-sectional area of the winding leg 18 to remain approximately constant throughout the length of the winding leg 18.

In the presently-preferred method described herein, the material strips 36 are cut so that the winding leg 18 has a cross-section that approximates a circle when the laminae 25 are stacked in the order in which they are cut from one or more of the material strips 36 (see FIG. 6). The lines 40 depicting the paths along which the material roll 39 is cut preferably have a curvilinear profile to provide the winding leg 18 with the noted cross-section (see FIG. 4). In other words, the width of each material strip 36 preferably changes in a non-linear fashion along the length of the material strip 36.

The above-noted details concerning the manufacture and assembly of the winding leg 18 apply equally to the yokes 14, 16 and the outer legs 20, 21. Hence, further details concerning the manufacture and assembly of the yokes 14, 16 and the outer legs 20, 21 are not presented herein.

The windings phase 31a, 31b are subsequently placed on the winding leg 18 in a conventional manner. The upper and lower yokes 14, 16, the winding leg 18, and the outer legs 20, 21 are then fixedly coupled in the previously-described manner to form the core 12.

The substantially circular cross-section of the winding leg 18 permits the phase windings 31a, 31b to closely conform to the shape of the winding leg 18, thereby minimizing the potential for flux leakage from the core 12 (see FIG. 6). In other words, the winding leg 18 has an optimal cross-section with respect to minimizing flux leakage from the core 12. The manufacturing method described herein achieves this advantage without the need to individually cut each lamina 25, 26, 27 to a particular width. Rather, the variation in width of among the laminae 25, 26, 27 is achieved by forming the material strips 26 so that the width of each strip 26 varies along its length in a predetermined manner.

Thus, the presently-preferred method provided by the invention substantially reduces the overall number of activities required to manufacture a core such as the core 12. In particular, the use of the preferred method facilitates the manufacture of a stacked core having an optimal geometric profile with respect to flux leakage, without the substantial expenditure of labor associated with individually cutting each lamina in the core to a particular width. Hence, the preferred method provides a process for manufacturing a stacked core that involves less time, effort, and expense than a conventional manufacturing process for a stacked core having comparable flux-leakage characteristics. In addition, the use of the preferred method results in little or no waste of the magnetic material used in the manufacturing process.

It is to be understood that even though numerous characteristics and advantages of the present invention have been set forth in the foregoing description, together with specific details of a presently-preferred method, the disclosure is illustrative only, and changes may be made in detail, especially in matters of shape, size, and arrangement of the parts, within the principles of the invention to the full extent indicated by the broad general meaning of the terms in which the appended claims are expressed.

For example, a presently-preferred method has been described in connection with a core 12 comprising a winding leg 18, yokes 14, 16, and outer legs 18, 20 having circular cross-sections. Furthermore, the winding leg 18, yokes 14, 16, and outer legs 18, 20 of the exemplary core 12 are each formed from a relatively large number of the laminae 25, 26, 27. The use of a relatively large number of the laminae 25, 26, 27 causes the cross section of each of the winding leg 18, yokes 14, 16, and outer legs 18, 20 to closely approximate a circle.

Alternatively, the winding leg 18, yokes 14, 16, and outer legs 18, 20 may each be formed from a smaller number of laminae 25, 26, 27. Reducing the number of laminae 25, 26, 27 from which the winding leg 18, yokes 14, 16, and outer legs 18, 20 are formed causes the cross sections of those components to deviate from the ideal substantially circular shape described above. Thus, the contemplated scope of the present invention is not limited to the manufacture of stacked cores comprising legs and yokes having substantially circular cross sections. For example, legs and yokes having cross sections that only roughly approximate the shape of a circle can be manufactured in accordance with the invention. Furthermore, legs and yokes having cross sections that approximate other geometric shapes, e.g., an ellipse, can also be manufactured in accordance with the invention. Hence, the following claims are not limited to the manufacture of transformer cores comprising legs and yokes having substantially circular cross sections, unless expressly stated otherwise.

What is claimed is:

1. A method of manufacturing a stacked core for a magnetic-induction device, comprising:
cutting one or more strips of magnetic material from a sheet of the magnetic material so that each of the strips has a width that varies in a predetermined manner along a length of the strip;
cutting the one or more strips to form a plurality of laminae; and
stacking and bonding the laminae to form a winding leg having a substantially circular cross-section.

2. The method of claim 1, further comprising stacking and bonding the laminae to form a first yoke and a first outer leg each having a substantially circular cross-section.

3. The method of claim 2, further comprising stacking and bonding the laminae to form a second yoke and a second outer leg each having a substantially circular cross-section, and fixedly coupling the winding leg, the first and second yokes, and the first and second outer legs.

4. The method of claim 3, wherein fixedly coupling the winding leg, the first and second yokes, and the first and second outer legs comprises fixedly coupling opposing ends of the first and second outer legs to opposing ends of the first and second yokes and fixedly coupling opposing ends of the winding leg to approximate mid-points of the first and second yokes.

5. The method of claim 1, wherein cutting one or more strips of magnetic material from a sheet of the magnetic material comprises cutting the strips from the sheet so that the width of each of the strips varies non-linearly along the length of the strip.

6. A method of manufacturing a stacked core for a magnetic-induction device, comprising:
forming a strip of magnetic material of varying width;
forming laminae of different widths from the strip of magnetic material; and
stacking and bonding the laminae to form a winding leg.

7. The method of claim 6, further comprising stacking and bonding the laminae to form a yoke and an outer leg.

8. The method of claim 6, further comprising placing a phase winding on the winding leg.

9. The method of claim 7, further comprising fixedly coupling the winding leg, the yoke, and the outer leg.

10. The method of claim 7, further comprising stacking and bonding the laminae so that the winding leg, the yoke, and the outer leg each have a substantially circular cross-section.

11. The method of claim 10, wherein stacking and bonding the laminae so that the winding leg, the yoke, and the outer leg each have a substantially circular cross-section comprises stacking the laminae so that (i) laminae of relatively large width are positioned at respective approximate centers of the winding leg, the yoke, and the outer leg, (ii) laminae of relatively small width are positioned at respective outer edges of the winding leg, the yoke, and the outer leg, and (iii) laminae of progressively decreasing width are positioned between the respective approximate centers and the respective outer edges of the winding leg, the yoke, and the outer leg.

12. A method of manufacturing a stacked core for a magnetic-induction device, comprising:
cutting a sheet of magnetic material into one or more strips so that a width of each of the strips changes in a predetermined manner along a length of the strip;
cutting the strips to form a plurality of laminae having different widths;
stacking the laminae to form a stack of the laminae having laminae of relatively large width positioned at an approximate center of the stack, laminae of relatively small width positioned at outer edges of the stack, and laminae of progressively decreasing width positioned between the approximate center and the outer edges of the stack; and
bonding the laminae to form a winding leg.

13. A method of manufacturing a stacked core for a magnetic-induction device, comprising:
cutting a sheet of magnetic material into a strip of the magnetic material having a width that decreases progressively along a length of the strip;
cutting the strip to form a plurality of laminae having different widths; and
stacking the laminae in a sequence substantially identical to a sequence in which the laminae are cut from the strip so that the laminae are arranged in an order of progressively changing width.

14. The method of claim 13, wherein stacking the laminae in a sequence substantially identical to a sequence in which the laminae are cut from the strip comprises stacking and bonding the laminae to form a winding leg having a substantially circular cross-section.

15. The method of claim 14, wherein stacking the laminae in a sequence substantially identical to a sequence in which the laminae are cut from the strip comprises stacking and boding the laminae to form a yoke and an outer leg each having a substantially circular cross-section.

16. The method of claim 15, further comprising fixedly coupling the winding leg, the yoke, and the outer leg.

17. The method of claim 13, wherein cutting a sheet of magnetic material into one or more strips so that a width of each of the strips changes along a length of the strip comprises cutting the sheet along a substantially curvilinear path.

18. A method of manufacturing a stacked core for a magnetic-induction device, comprising:
cutting a sheet of magnetic material along a substantially curvilinear path to form a strip of the magnetic material having a varying width;
cutting the strip to form a plurality of laminae; and
stacking and bonding the laminae to form a winding leg.

19. The method of claim 18, wherein stacking and bonding the laminae to form a winding leg comprises stacking and bonding the laminae to form a winding leg having a substantially circular cross-section.

20. The method of claim 19, wherein stacking and bonding the laminae to form a winding leg having a substantially circular cross-section comprises stacking the laminae so that laminae of relatively large width are positioned at an approximate center of the winding leg, laminae of relatively small width are positioned at outer edges of the winding leg, and laminae of progressively decreasing width are positioned between the approximate center and the outer edges of the winding leg.

21. The method of claim 18, further comprising stacking and bonding the laminae to form an upper and a lower yoke and a first and a second outer leg, and fixedly coupling the winding leg, the upper and lower yokes, and the first and second outer legs.

22. The method of claim 21, wherein fixedly coupling the winding leg, the first and second yokes, and the first and second outer legs comprises fixedly coupling opposing ends of the first and second outer legs to opposing ends of the first and second yokes and fixedly coupling opposing ends of the winding leg to approximate mid-points of the first and second yokes.

23. A stacked transformer core, comprising a winding leg formed from a plurality of laminae having different widths, the laminae being stacked and bonded so that (i) laminae of relatively large width are positioned at an approximate center of the winding leg, (ii) laminae of relatively small width are positioned at outer edges of the winding leg, and (iii) laminae of progressively decreasing width are positioned between the approximate center and the outer edges of the winding leg, whereby a cross-section of the winding leg is substantially circular.
